(19) United States
(12) Patent Application Publication
(10) Pub. No.: US 2025/0102716 A1
(43) Pub. Date: Mar. 27, 2025

(54) ARTICLES AND METHODS FOR GENERATING TUNABLE COLORATION AND INTERFERENCE UPON REFLECTION OF INCIDENT ELECTROMAGNETIC RADIATION

(71) Applicant: THE PENN STATE RESEARCH FOUNDATION, University Park, PA (US)

(72) Inventors: Lauren Dell ZARZAR, University Park, PA (US); Caleb Huw MEREDITH, University Park, PA (US); Nathaniel Erik STURNIOLO, University Park, PA (US)

(21) Appl. No.: 18/723,219

(22) PCT Filed: Dec. 22, 2022
(86) PCT No.: PCT/US22/53864

§ 371 Date: Jun. 21, 2024

Related U.S. Application Data
(60) Provisional application No. 63/292,837, filed on Dec. 22, 2021.

(51) Int. Cl. G02B 5/28; G02F 1/21

(52) U.S. Cl. CPC G02B 5/286; G02F 1/216; G02F 1/218

(57) ABSTRACT

Disclosed are articles, embodiments, and methods of formation related substrates which exhibit a tunable interference pattern (e.g., structural color) upon reflection of incident electromagnetic radiation.

### CROSS-REFERENCE TO RELATED APPLICATIONS

This application claims benefit of priority of U.S. Provisional Application No. 63/292,837, filed Dec. 22, 2021, which is incorporated herein by reference.

### STATEMENT REGARDING FEDERALLY SPONSORED RESEARCH OR DEVELOPMENT

This invention was made with government support under Grant IIP-2016420 awarded by the National Science Foundation. The Government has certain rights in the invention.

### BACKGROUND

Materials capable of generating unique visual appearances and spectral signatures possess significant impact to be deployed in diverse application including optical security features, reflective signs and road markings, decorative films, paints, optical filters, sensors, and camouflaging coatings. Structural colors produced by the interference of light are of special interest because they do not fade (unlike dyes) and may exhibit iridescence, meaning the color and intensity of reflected light shifts with changes in illumination or viewing angle. Structural colors are typically generated when light interacts with periodic nanostructures, such as diffraction gratings, thin-films, or photonic crystals with feature sizes on the order of the wavelength of visible light (100's of nanometers). The optical customizability of such nanostructured iridescent materials, such as the hue/shade or the angular positions and separation of colors, is inherently limited by geometric constraints imposed by those interference mechanisms' adjustment of optical pathlengths (and hence color) by tuning one or two critical dimensions, such as film thickness or grating spacing. Alternate approaches for producing structural color have recently been demonstrated through interference occurring when light undergoes multiple consecutive total internal reflection (TIR) events at the interfaces of concave microstructures on the 1 to 100 μm scale. By controlling light trajectories and interference in three-dimensional microscale cavities, additional geometric degrees of freedom enable the creation of tunable iridescent appearances distinguished by wide angular separations of colors (up to 10's of degrees) and a range of accessible hues. However, interference produced from microscale structures relying on TIR to control light trajectories necessitate specific ordering and changes in the refractive indices of substrate materials and only reflect light at certain angles of incidence that satisfy the TIR condition, limiting the overall range of materials and interfaces which can be utilized to create structural colors. Accordingly, improved articles, methods, and compositions are needed.

### SUMMARY

Provided herein are articles and methods for creating iridescent structural color with large angular spectral separation and tunable interference patterns using microscale structures without relying on TIR. The effect can be generated at interfaces with dimensions that are up to orders of magnitude larger than wavelengths of visible light. Variation in structural color is observed when the substrate is viewed from different angular positions or under varying illumination conditions. Structural color is observed due to interference produced by light interacting with the geometric structure of an interface allowing trajectories of light to undergo two or more reflections (e.g., reflecting within a hemicylindrical/concave interference between a polymer and metal film). The pattern of interference depends on interface geometry and is determined by variation between the path lengths traveled by different trajectories of reflected light (e.g., differences in numbers of bounces, incident angles, phase shifts, and positions).

Articles exhibiting iridescent structural color resulting from multiple TIR light reflections have been demonstrated using concave microscale interfaces between a high and low refractive index material. However, a condition for TIR to occur is that the light must experience sharp change in refractive index from high to low at an interface, where the light impinges upon the interface above a critical angle of incidence. Accordingly, control over the reflected trajectories of light using TIR as the mode of reflection is sensitive to small changes in refractive indices of substrate materials is limited by the critical angle requirement, and necessitates specific ordering of high and low refractive index mediums. Consequently, the overall range of substrate materials and processing methods used to produce microstructured substrates exhibiting structural color and reflected interference patterns are constrained.

Herein, we describe an alternate class of microstructured substrates capable of generating tunable interference patterns upon reflection of incident electromagnetic radiation without TIR. Described are a variety of substrate architectures, including two-dimensional and three-dimensional patterned surfaces, and methods of making substrates that exploit the principles described above to create iridescent structural colors and interference of light.

For example, provided are substrates that comprise a first material having a surface and comprising plurality of microstructures disposed on or within the surface; and a reflective layer disposed on and abutting the first material, thereby forming a reflective surface on or within each of the plurality of microstructures. In some embodiments, each of the microstructures can have a height and a width of at least 1 micron. In some embodiments, the reflective surface can be structured such that a portion of electromagnetic radiation incident a surface of the substrate at an illumination angle undergoes two or more reflections within a microstructure, thereby generating an interference pattern upon incident illumination.

In some embodiments, the reflective layer has a thickness of less than 1 micron (e.g., a thickness of less than 250 nm, such as a thickness of from 5 nm to 100 nm). In some embodiments, the reflective layer can comprise an inorganic material (e.g., a metal or alloy, such as silver, chromium, gold, platinum, palladium rhodium, iridium, aluminum, titanium, nickel, zinc, copper, iron, vanadium, cobalt, tungsten, zirconium, indium, stainless steel, nichrome, bronze, rose gold, white gold, or combinations thereof; a semiconductor, such as carbon, silicon, germanium, tin, zinc selenide, or zinc sulfide; or a metal oxide, such as titanium oxide, magnesium oxide, aluminum oxide, chromium oxide, zinc oxide, or silicon oxide).

In certain embodiments, the substrate can further comprise an inorganic layer disposed on and abutting the reflective material, thereby forming an interface between the reflective surface and the inorganic layer on or within each of the plurality of microstructures. In some embodiments, the inorganic layer has a thickness of less than 1 micron (e.g., a thickness of less than 400 nm or less than 250 nm, such as a thickness of from 5 nm to 100 nm). In some embodiments, the inorganic layer can comprise a metal oxide, dielectric, semiconductor, or combination thereof. For example, the inorganic layer can comprises aluminum oxide, barium-strontium-titanate (BST), erbium oxide, hafnium oxide, hafnium silicate, lanthanum oxide, niobium oxide, lead-zirconium-titanate (PZT), a bilayer of silicon oxide and silicon nitride, silicon oxy-nitride, strontium titanate (STO), tantalum oxide, titanium oxide, zirconium oxide, silicon, germanium, gallium arsenide, silicon carbide, indium-tin-oxide, gallium nitride, gallium phosphide, cadmium sulfide, lead sulfide, zinc selenide, zinc sulfide, or a combination thereof.

Also provided are substrates that comprise a reflective material having a reflective surface and comprising plurality of microstructures disposed on or within the surface, wherein each of the microstructures have a height and a width of at least 1 micron, and wherein the reflective surface of each of the plurality of microstructures are structured such that a portion of electromagnetic radiation incident a surface of the substrate at an illumination angle undergoes two or more reflections within the microstructure, thereby generating an interference pattern upon incident illumination.

In some embodiments, the reflective material can comprise an inorganic material (e.g., a metal or alloy, such as silver, chromium, gold, platinum, palladium rhodium, iridium, aluminum, titanium, nickel, zinc, copper, iron, vanadium, cobalt, tungsten, zirconium, indium, stainless steel, nichrome, bronze, rose gold, white gold, or combinations thereof; a semiconductor, such as carbon, silicon, germanium, tin, zinc selenide, or zinc sulfide; or a metal oxide, such as titanium oxide, magnesium oxide, aluminum oxide, chromium oxide, zinc oxide, or silicon oxide).

In certain embodiments, the substrate can further comprise an inorganic layer disposed on and abutting the reflective material, thereby forming an interface between the reflective surface and the inorganic layer on or within each of the plurality of microstructures. In some embodiments, the inorganic layer has a thickness of less than 1 micron (e.g., a thickness of less than 400 nm or less than 250 nm, such as a thickness of from 5 nm to 100 nm). In some embodiments, the inorganic layer can comprise a metal oxide, dielectric, semiconductor, or combination thereof. For example, the inorganic layer can comprises aluminum oxide, barium-strontium-titanate (BST), erbium oxide, hafnium oxide, hafnium silicate, lanthanum oxide, niobium oxide, lead-zirconium-titanate (PZT), a bilayer of silicon oxide and silicon nitride, silicon oxy-nitride, strontium titanate (STO), tantalum oxide, titanium oxide, zirconium oxide, silicon, germanium, gallium arsenide, silicon carbide, indium-tin-oxide, gallium nitride, gallium phosphide, cadmium sulfide, lead sulfide, zinc selenide, zinc sulfide, or a combination thereof.

As described below, the substrates described herein can be formed or incorporated on and/or into articles, such as banknotes, checks, money orders, passports, visas, vital records, identification cards, credit cards, atm cards, licenses, tax stamps, postage stamps, lottery tickets, deeds, titles, certificates, legal documents, packaging components, stickers, and authentication tags. In some embodiments, the substrate can serve as a security or anticounterfeiting feature. In some embodiments, the substrate can provide an aesthetic benefit. In some embodiments, the substrate forming the article or incorporated on or into the article can appear to transform from a first form, shape, size or color to a second form, shape, size or color upon rotation of the article about an axis parallel to the surface.

### DESCRIPTION OF DRAWINGS

FIG. 1A is a schematic illustration of a horizontal cross section of a concave microscale geometry exhibiting structural color due interference produced by multiple reflections of incident light. White light impinging on a concave surface undergoes a series of reflection events leading to different paths of varying lengths, resulting in a shift in phase that causes interference and structural color. FIGS. 1B and 1C illustrate horizontal cross sections of alternative microscale geometries delimited by facets and Bézier curves which can also exhibit structural color by multiple reflections of incident light. FIG. 1D shows an alternative embodiment in which the first material is a reflective material, such that no separate layer is required (though one can optionally be included).

FIGS. 2A and 2B depict the surface profile obtained from optical profilometry of a three-dimensional array of microscale dome structures (hemicylinders) capable of generating structural color from the interference between light rays reflecting multiple times. The convex microstructures have a pitch of 11.0 μm, a width of 8.1 μm+/−0.4 μm and a height of 7.3 μm+/−0.2 μm. The textured substrate is comprised of convex (dome) microstructures formed in OG-142 epoxy, replicated from a concave PDMS mold formed from a lithographically produced master. The substrate may serve as an appropriate surface for templating a reflective coating (e.g., metallic film) to produce iridescent structural color.

FIG. 3 is a schematic illustration of the method used to characterize the interference patterns of iridescent colors from reflective substrates by projecting the reflected colors onto a translucent screen (planarized or curved). A collimated white LED light source is illuminated onto the surface at a defined incidence angle. For asymmetric, linearized/hemicylindrical structures the orientation angle of the structures with respect to the light angle is also recognized. The reflected colors produced by the substrate are projected onto the inside surface of the translucent screen.

FIG. 4A-D show the interference patterns obtained from a set of substrates containing arrays of reflective microstructures each with the same dimensions shown in FIG. 2A but with different materials abutting the interface. FIG. 4A shows the interference pattern obtained from a substrate utilizing TIR to produce interference through the multiple reflections of light. FIG. 4B does not produce an interference pattern due to unfulfilled refractive index conditions for TIR and a lack of a highly reflective interface. FIGS. 4C and 4D show the interference patterns obtained from interference between multiple reflections without TIR, achieved after applying a reflective metal layer (100 nanometer thick aluminum) on to the polymer substrates in FIGS. 4B and 4A respectively. The interference patterns were obtained using the experimental method illustrated and described in FIG. 3 where θ=45 degrees and Φ=90 degrees.

FIG. 5 illustrates a comparison in the reflected interference exhibited by microstructured substrate constructions comprised of different ordering and layers of reflective and transparent materials with different refractive indices (LRI, low-refractive index and HRI, high refractive index materials). In the first row, the substrate relying on TIR to control the multiple reflections of incident light is only able to produce structural color from an ordering of substrate layers accommodating a high refractive index (HRI) to low refractive index (LRI) transition as light impinges from above. In the second and third rows, all four depicted constructions containing a reflective metal film sandwiched between different high and low refractive index media can produce structural color by interference produced by multiple reflections using a metal to create reflectivity.

FIG. 6 is an illustration depicting a bulk material surface containing a plurality of reflective microstructures exhibits interference patterns and iridescent structural color when submerged or covered with a variety of fluids and transparent solid material layers.

FIGS. 7A and 7B illustrates examples of particulates and flakes formed from the reflective substrates described herein, as well as coatings formed from these particulates and flakes.

FIG. 8A depicts a method used to fabricate reflective substrates using a series of two process steps. In the first step, a roll-to-roll microreplication process is used to form a plurality of microscale structures in a polymeric substrate from a hard interface master. In the second process step, the deposition of a film of reflective material (e.g., metallization) is added to produce a reflective substrate capable of exhibiting interference patterns and iridescent structural color. FIG. 8B is a schematic depicting an alternate deposition process where the flux of deposited material is directed at a defined angle with respect to the substrate in order to produce a shadowing effect, where an asymmetric profile of deposited material is obtained across the substrate surface.

FIG. 9 is an illustration depicting a substrate with patterned reflective properties produced by the spatially controlled layering of reflective materials onto an interface comprising curved microstructures.

FIG. 10A-C shows the reflection obtained from a set of flat OG-142 epoxy substrates with and without different layers of inorganic materials abutting the interface. 10D-F show the reflection and interference patterns obtained from a set of substrates containing arrays of concave (well) microstructures each with a similar hemicylindrical cross-sectional profile as shown in FIG. 2A, with and without additional layers of inorganic materials abutting the interface as used in FIG. 10B-C. The concave microstructures have a pitch of 15.0 μm, a width of 11.7 μm+/−0.3 μm and a depth of 9.8 μm+/−0.2 μm. FIG. 10A shows the reflection pattern obtained from a flat uncoated polymer substrate does not produce an interference pattern due to a lack of a reflective surface within the microstructures. FIG. 10B shows the reflection pattern achieved after applying an opaque reflective metal layer of 225 nm chromium onto the polymer substrate from FIG. 10A which does not result in an interference pattern due to lack of reflective microstructures. FIG. 10C shows the colored reflection pattern achieved after applying a dielectric layer of 300 nm titanium oxide onto the metalized substrate from FIG. 10B which results in green coloration due to thin film interference produced by the dielectric and metal inorganic layers. FIG. 10E shows the interference pattern achieved after applying an opaque reflective metal layer of 225 nm chromium onto the polymer substrate from FIG. 10D. FIG. 10F shows the interference pattern achieved after applying a dielectric layer of 300 nm titanium oxide onto the metalized substrate from FIG. 10E which results a primarily red color distinct from the green reflected appears observed for the layering of inorganic materials on top the flat polymer substrate.

FIG. 11 shows the macroscopic appearance and corresponding interference patterns obtained from substrates patterned with four different arrays of concave reflective microstructures layered with films of inorganic materials abutting the interface. The microstructures possess cross sectional profiles similar to the features in FIG. 2A but possessing varying depths/aspect ratios. The textured substrate is comprised of concave microstructures formed in OG-142 epoxy replicated from a convex PDMS mold formed from a lithographically produced master subsequently coated on their textured surface with inorganic layers of 225 nm chromium and 300 nm titanium oxide by thermal evaporation (same as deposited layers for FIGS. 10C and F). Each array contains concave microstructures with a pitch of 15.0 μm, a width of 11.7 μm+/−0.3 μm and having depths (as shown from left to right) of 8.5 μm, 9.8 μm, 10.7 μm, and 11.4 μm+/−0.2 μm.

FIG. 12 illustrates a comparison in the reflected interference exhibited by microstructured substrate constructions comprised of different ordering and layers of two layers of thin film materials. In the first row, a thin layer of deposited transparent or semitransparent material, such as an oxide or semiconductor, is deposited on top of a deposited layer of opaque metal coated on top of a surface containing concave and or convex microstructures formed in a polymer material. Light impinging from above may undergo interference due to a path length differences resulting from combination of multiple reflections within micro-scale structures as well as thin film interference generated between the nano-scale oxide or semiconductor and metal film layers. In the second row, the ordering of thin film layers is switched so that the oxide or semiconductor film is deposited onto the microstructured polymer surface before the metal layer.

FIG. 13 illustrates examples of particulates and flakes formed from the reflective substrates described herein comprised of two or more inorganic layers, as well as coatings formed from these particulates and flakes.

FIG. 14 is a schematic illustration demonstrating how arrays of perpendicularly patterned hemicylinders can produce varying colors and optical effects in a substrate. By varying the orientation of the reflective hemicylinders in some regions of the surface with respect to other reflective hemicylinders in other regions of the surface, the surface can be patterned such that the substrate can exhibit varying structural colors within different regions at a particular viewing angle. As the viewing angle is changed (e.g., by rotating the substrate), the structural color exhibited by different regions can change.

### DETAILED DESCRIPTIONS AND EXAMPLES

The invention will be described in greater detail by way of specific examples. The following examples are offered for illustrative purposes and are not intended to limit the invention in any manner. Those of skill in the art will readily recognize a variety of non-critical parameters which can be changed or modified to yield essentially the same results.

### Definitions

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

The terms “iridescent” and “iridescence” as used herein are each given its ordinary meaning in the art and generally refer to color that changes as a function of light incidence and/or viewing angle.

The term “reflective” or “reflection” or “reflecting” as used herein are each given its ordinary meaning in the art and refer to the casting back of incident electromagnetic radiation at an interface or surface, but a reflection or a reflecting interface or surface need not be total such that some fraction of electromagnetic radiation may be either absorbed or transmitted while some fraction of electromagnetic radiation is reflected. Reflections can occur, for example, at the surface of a metal (e.g., a silver mirror), a multilayer material (e.g., a distributed Bragg reflector), or at an interface with refractive index contrast (e.g., an air-glass interface). Depending on material properties, the reflectivity of a surface may vary as a function of the incident electromagnetic radiation.

Described herein are articles and methods for the generation of tunable electromagnetic radiation such as coloration (e.g., iridescence, structural color) and/or interference patterns from, for example, two-dimensional and three-dimensional microstructured surfaces (e.g., comprising a plurality of microdomes and/or microwells, such as a surface comprising a plurality of hemicylindrical features). In some embodiments, the surfaces can produce visible color (e.g., structural color) and interference patterns of non-visible wavelengths (i.e., ultra-violet, infrared, microwaves) without the need for dyes. Such colors may be generated in articles wherein the morphology of the surfaces can be controlled dynamically, which may permit the tunability of the perceived spectrum throughout the visible, infrared, UV, microwave, regions, etc. (e.g., containing wavelengths of 1 nanometer to 1 centimeter). In some embodiments, the surface morphology may be fixed such that the surface obtains a permanent color (or array of colors) or interference pattern. In some cases, substrates derived thereof may be used to generate structural coloration using curved and/or polygonal material reflective surfaces and interfaces e.g., that create spectral separation by interference effects occurring due to, for example, cascaded reflections of light at the surface/interface. In some embodiments, the surfaces described herein comprise a reflective surface and/or interface (e.g., a reflective surface or an interface between two or more materials where reflection can occur) and a geometry in which multiple reflections can occur. Without wishing to be bound by theory, electromagnetic radiation travelling along different trajectories of reflection at a reflective surface and/or interface may, in some cases, interfere, generating color, and/or generating interference effects such as interference patterns. In some embodiments, a first portion of the electromagnetic radiation may undergo reflection and a second portion of the electromagnetic radiation is reflected (e.g., by a mechanism different from the first reflection). In some embodiments, substantially all electromagnetic radiation incident to the reflective surface and/or interface undergoes reflection. In some embodiments, a portion of the electromagnetic radiation incident to the interfaces undergoes reflection. In some embodiments, reflection of electromagnetic radiation at the microstructured reflective surface and/or interface generates interference that is different in wavelength from reflection of electromagnetic radiation off a flat surface comprised of the same material(s).

In certain embodiments, the structural color may be tuned by changing the curvature, radius of curvature, and/or angles of the sides the reflective surface and/or interface on or within the microstructures, the dimensions of the microstructures (e.g., the height of the microstructures, the width of the microstructures, the aspect ratio of the microstructures, or a combination thereof), the relative orientation of microstructures with respect to other microstructures on or within the surface, and/or the reflectivity, chemical identity, and/or refractive index of one or more materials at the reflective surface and/or interface. Non-limiting examples of suitable interfaces for generating tunable coloration include solid-solid interfaces (e.g. abutting layers of solid materials), solid-gas interfaces (e.g. a metallized microstructured surface in air), and solid-liquid interfaces (e.g. a metallized microstructured surface submerged in liquid such as water).

Unlike the precise nanoscale periodicity generally required to create structural color from diffraction gratings, photonic crystals, or multilayers, the optical interference created by multiple reflections as described herein may, in some embodiments, advantageously be generated at concave reflective surfaces and/or interfaces with dimensions on the microns scale (e.g., having a characteristic dimension of greater than or equal to 1 micron and less than or equal to 1000 microns, greater than or equal to 1 micron and less than or equal to 250 microns, greater than or equal to 5 microns and less than or equal to 250 microns).

Without wishing to be bound by theory, generation of tunable coloration, patterns of coloration, or interference patterns may be due to interference phenomena occurring when light undergoes multiple reflections at curved, microscale, nanoscale, or macroscale reflective surface and/or interface (e.g., at an interface between two or more abutting or adjacent materials). Such tunable coloration or interference patterns may be implemented in a variety of materials and systems including 2D and 3D patterned surfaces without the need for precise control of nanoscale periodicity. As such, the substrates described herein may be useful in a wide range of applications including inks, paints, cosmetics, personal care products, displays, sensors (e.g., colorimetric sensors for chemical and/or physical parameters such as heat, presence of an analyte (e.g., chemical, biological component), pressure, mechanical deformation, humidity, etc.), binders, displays and signage, point-of-care medical diagnostics, coatings, as well as for fundamental exploration in fields ranging from optics and photonics to complex fluids and colloids.

The substrates, articles, and methods as described herein offer numerous advantages to systems known in the art, for producing color or optical interference. For example, the substrates described herein may, in some cases, produce structural color (e.g., more brilliant and longer lasting compared to dyes), produce tunable color (e.g., such that small changes in the shape of the interface can be used to alter the color which is useful for, for example, sensors and displays), do not require nanoscale particles and/or chemical fluorophores and/or pigments, provide a colorimetic readout (e.g., for responsive sensors), generate color in reflection, generate an optical interference pattern, and/or use only environmental light as the light source.

In some embodiments, the color generated by the substrate is due, at least in part, reflection of electromagnetic radiation. For example, light entering the substrate may be refracted at an interface between air and a coating comprising a second material, then undergo reflection. In some embodiments, such refraction causes an initial color separation (e.g., due to optical dispersion). In certain embodiments, during and/or after refraction, light propagates between the reflective layer/material and an inorganic layer via reflection events that need not occur all by the same reflection mechanism.

### Substrates

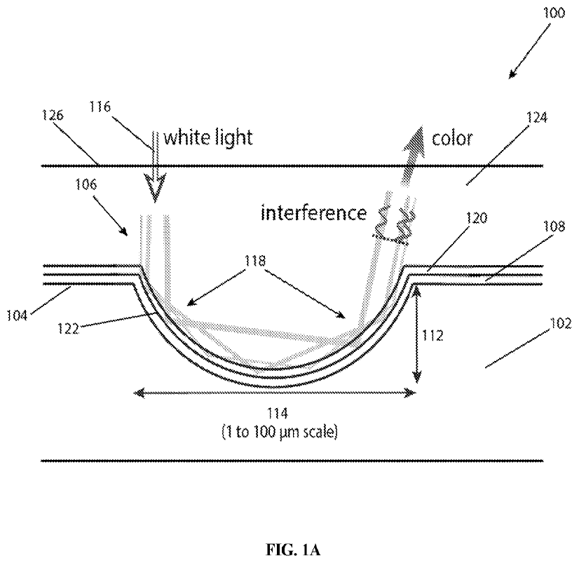

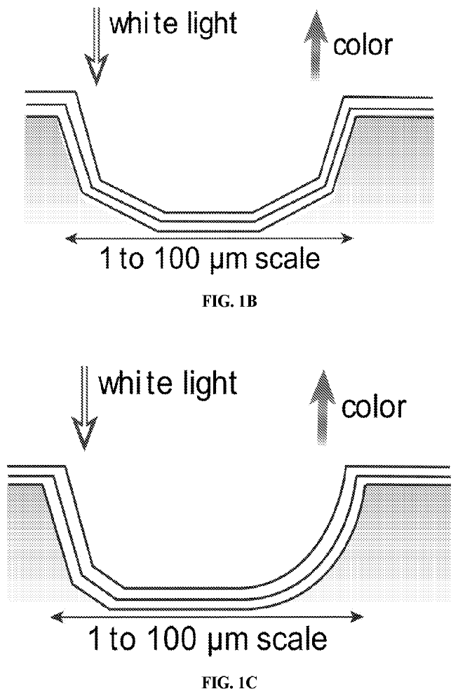

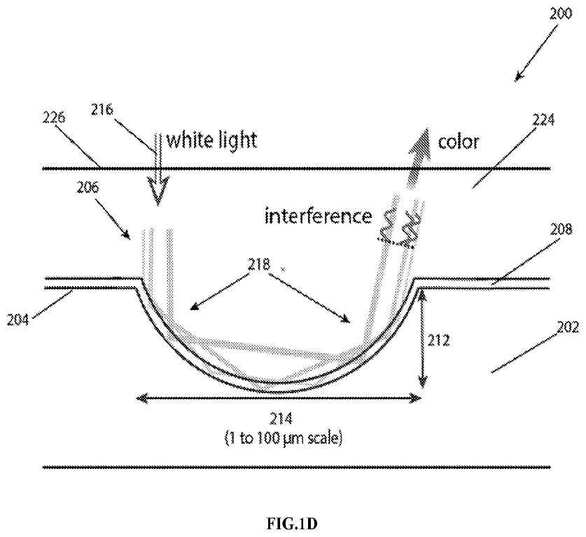

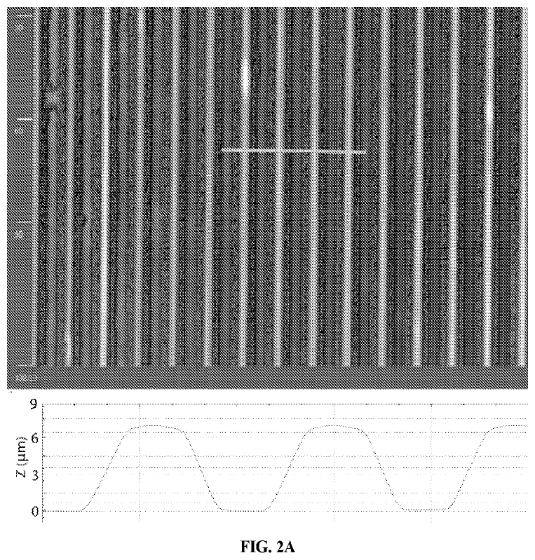

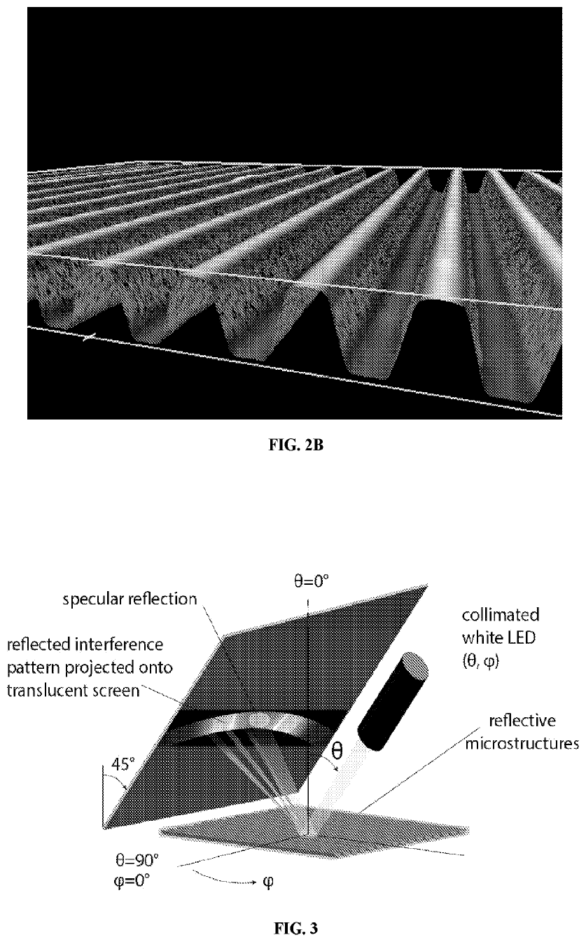

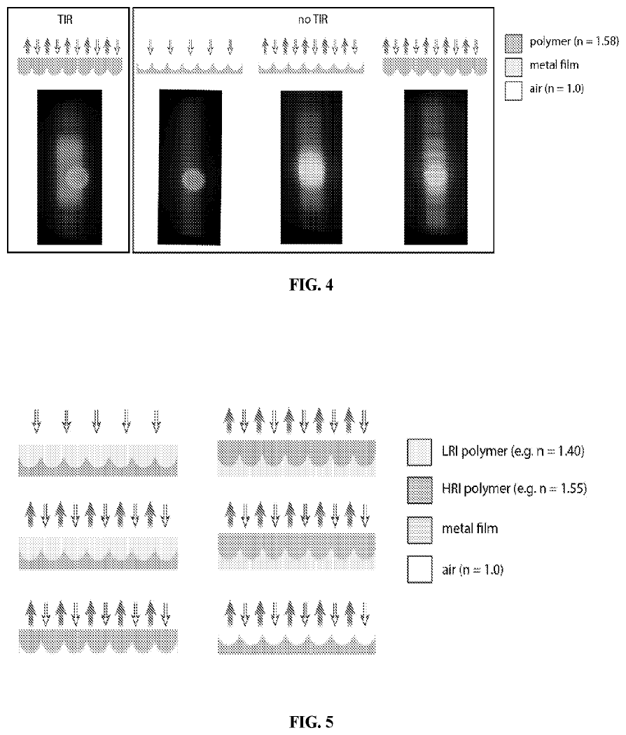

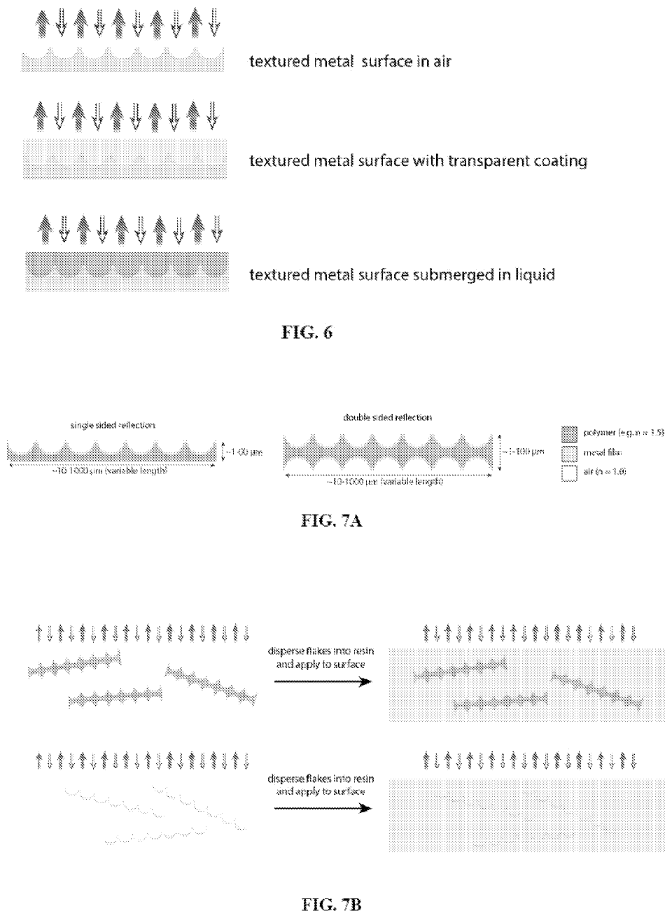

Described herein are substrates comprising a plurality of microstructures that exhibit an interference pattern upon reflection of incident electromagnetic radiation. Referring now to FIG. 1A, provided herein substrates (100) that comprise a first material (102) having a surface (104) and comprising plurality of microstructures (106) disposed on or within the surface (104). A reflective layer (108) can be disposed on and abutting the first material, thereby forming a reflective surface (122) on or within each of the plurality of microstructures (106). As used herein, when a material is referred to as “abutting” or being “adjacent” to another material, it can be directly abutting or adjacent to the other material, or one or more intervening layers (e.g., layers including, but not limited to, a third material, a polymer layer, a glass layer, a metal, a coating, and/or a fluid) also may be present. A material that is “directly abutting” or “directly adjacent” another component means that no intervening layer is present. In certain embodiments, reflective layer (108) can be disposed on and directly abutting the first material, thereby forming a reflective surface (122) on or within each of the plurality of microstructures (106).

Referring again to FIG. 1A, the reflective surface (122) is structured such that at least a portion of electromagnetic radiation (116) incident a surface (126) of the substrate (100) at least one illumination angle undergoes multiple reflection events (118) within the microstructure (e.g., resulting in spectral color generation or interference). For example, the electromagnetic radiation incident on a surface of the substrate at least one illumination angle can undergo at least two reflections, at least three reflections, at least reflections, at least five reflections, at least ten reflections, or many more reflections. The number of reflections can vary based on the geometry of the reflective surface, the identity of the reflective material, the presence of additional components within the substrate (as discussed in more detail below), and the illumination angle of the incident light.

While labeled and illustrated as white light, one of ordinary skill in the art will understand that the incident electromagnetic radiation can comprise varying portions or subsections of the electromagnetic spectrum (and by extension the resulting interference can be generated in various regions of the electromagnetic spectrum). By way of example, in some embodiments, the incident electromagnetic radiation can comprise visible light, UV light, IR light, or a combination thereof. In some embodiments, the incident electromagnetic radiation can comprise visible light.

As illustrated in FIG. 1A, the each of the microstructures (106) can have a height (112) and a width (114). In some embodiments, each of the microstructures can have a height and a width of at least 1 micron.

In some embodiments, each of the microstructures can have a height of at least 1 micron (e.g., at least 2 microns, at least 3 microns, at least 4 microns, at least 5 microns, at least 6 microns, at least 7 microns, at least 8 microns, at least 9 microns, at least 10 microns, at least 11 microns, at least 12 microns, at least 13 microns, at least 14 microns, at least 15 microns, at least 16 microns, at least 17 microns, at least 18 microns, at least 19 microns, at least 20 microns, or at least 25 microns). In some embodiments, each of the microstructures can have a height of 30 microns or less (e.g., 25 microns or less, 20 microns or less, 19 microns or less, 18 microns or less, 17 microns or less, 16 microns or less, 15 microns or less, 14 microns or less, 13 microns or less, 12 microns or less, 11 microns or less, 10 microns or less, 9 microns or less, 8 microns or less, 7 microns or less, 6 microns or less, 5 microns or less, 4 microns or less, 3 microns or less, or 2 microns or less).

Each of the microstructures can have a height ranging from any of the minimum values described above to any of the maximum values described above. For example, in some embodiments, each of the microstructures can have a height of from 1 micron to 30 microns, such as from 1 micron to 20 microns, from 1 micron to 10 microns, or from 1 micron to 5 microns.

In some embodiments, each of the microstructures can have a width of at least 1 micron (e.g., at least 2 microns, at least 3 microns, at least 4 microns, at least 5 microns, at least 6 microns, at least 7 microns, at least 8 microns, at least 9 microns, at least 10 microns, at least 11 microns, at least 12 microns, at least 13 microns, at least 14 microns, at least 15 microns, at least 16 microns, at least 17 microns, at least 18 microns, at least 19 microns, at least 20 microns, at least 25 microns, at least 30 microns, at least 50 microns, or at least 75 microns). In some embodiments, each of the microstructures can have a width of 100 microns or less (e.g., 75 microns or less, 50 microns or less, 30 microns or less, 25 microns or less, 20 microns or less, 19 microns or less, 18 microns or less, 17 microns or less, 16 microns or less, 15 microns or less, 14 microns or less, 13 microns or less, 12 microns or less, 11 microns or less, 10 microns or less, 9 microns or less, 8 microns or less, 7 microns or less, 6 microns or less, 5 microns or less, 4 microns or less, 3 microns or less, or 2 microns or less).

Each of the microstructures can have a width ranging from any of the minimum values described above to any of the maximum values described above. For example, in some embodiments, each of the microstructures can have a width of from 1 micron to 100 microns, such as from 1 micron to 50 microns, from 1 micron to 30 microns, from 1 micron to 20 microns, or from 1 micron to 10 microns, or from 1 micron to 5 microns.

In some embodiments, each of the microstructures can have an aspect ratio (defined as the height of the microstructure divided by the width of the microstructure) of at least 0.1 (e.g., at least 0.2, at least 0.25, at least 0.3, at least 0.4, at least 0.5, at least 0.6, at least 0.7, at least 0.75, at least 0.8, at least 0.9, at least 1.0, at least 1.1, at least 1.2, at least 1.25, at least 1.3, at least 1.4, at least 1.5, at least 1.6, at least 1.7, at least 1.75, at least 1.8, or at least 1.9). In some embodiments, each of the microstructures can have an aspect ratio of 2.0 or less (e.g., 1.9 or less, 1.8 or less, 1.75 or less, 1.7 or less, 1.6 or less, 1.5 or less, 1.4 or less, 1.3 or less, 1.25 or less, 1.2 or less, 1.1 or less, 1.0 or less, 0.9 or less, 0.8 or less, 0.75 or less, 0.7 or less, 0.6 or less 0.5 or less, 0.4 or less, 0.3 or less, 0.25 or less, or 0.2 or less).

In some embodiments, each of the microstructures can have an aspect ratio ranging from any of the minimum values described above to any of the maximum values described above. For example, in some embodiments, each of the microstructures can have an aspect ratio of from 0.1 to 2, such as an aspect ratio of from 0.25 to 2, from 0.5 to 1.5, or from 0.75 to 1.25. In some embodiments, the microstructures can have a substantially constant aspect ratio along their length. In other embodiments, the aspect ratio of the microstructures can be varied along the length of the microstructures, so as to produce varying interference patterns along the length of the microstructure.

As shown in FIG. 1A, in some embodiments, the reflective surface (122) can be structured such that it is at least partially concave relative to incident electromagnetic radiation (116). For example, in some embodiments, each of the microstructures can comprise a well (e.g., microwell, hemisphere, or hemicylinder) formed within a first material. While this example microstructure can be entirely concave relative to incident electromagnetic radiation, one of ordinary skill in the art would understand that the suitable microstructures can include convex regions, provided that at least a portion of the microstructure is concave so as to provide for the desired reflection of incident light towards a viewer.

While much of the description herein describes the reflective surfaces and/or interfaces between arcuate (curved) surfaces, those of ordinary skill in the art would understand, based upon the teachings of this specification, that the term ‘curved’ shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

Referring now to FIGS. 1B and 1C, in other embodiments, the reflective surface and/or interface may comprise a plurality of flat surfaces (e.g., a polygonal interface) or facets, a combination of arcuate regions and faceted regions, or a combination of arcuate regions possessing varying radii of curvature. For example, in some embodiments, the curved surface comprises a plurality of sides. In some embodiments, the curved surface comprises two sides, three sides, four sides, five sides, six sides, seven sides, eight sides, nine sides, ten sides, or more. In some embodiments, at least a portion of the interface may be substantially flat. In certain embodiments, the interface comprises a truncated arcuate interface. Truncated arcuate interfaces can include a flattened bottom and curved vertical segments.

In some embodiments, the microstructures can have a substantially constant cross-sectional geometry along their length. In other embodiments, the cross-sectional geometry of the microstructures can be varied along the length of the microstructures, so as to produce varying interference patterns along the length of the microstructure.

As described above and herein, the plurality of reflective microstructures present within the substrate may be arranged in a two-dimensional or three-dimensional array. The phrase “two-dimensional array” is given its ordinary meaning in the art and generally refers to the ordered arrangement of objects (e.g., domes, wells) in e.g., ordered rows and columns in a two-dimensional plane comprising said objects. The phrase “three-dimensional array” is given its ordinary meaning in the art and generally refers to the ordered arrangement of objects (e.g., domes, wells) in e.g., ordered rows, columns, and slices (or planes) in a three-dimensional space. The arrangement of the wells, and/or domes may be positioned in a disordered array. In some embodiments, the plurality of reflective microstructures present within the substrate may be randomly distributed. Advantageously, in some embodiments, the substrates and methods described herein may produce coloration and/or interference without the need for ordered arrangement of the plurality of reflective microstructures present within the substrate.

In some embodiments, at least 10%, at least 20%, at least 30%, at least 40%, at least 50%, at least 60%, at least 70%, at least 80%, or at least 90% of the plurality of reflective microstructures present within the substrate are arranged in a regular two-dimensional array. In some embodiments, less than or equal to 100%, less than or equal to 90%, less than or equal to 80%, less than or equal to70%, less than or equal to 60%, less than or equal to 50%, less than or equal to 40%, less than or equal to 30%, or less than or equal to 20% of the plurality of reflective microstructures present within the substrate are arranged in a regular two-dimensional array. Combinations of the above-referenced ranges are also possible (e.g., at least 10% and less than or equal to 100%). Other ranges are also possible.

In some embodiments, at least 10%, at least 20%, at least 30%, at least 40%, at least 50%, at least 60%, at least 70%, at least 80%, or at least 90% of the plurality of reflective microstructures present within the substrate are arranged in a regular three-dimensional array. In some embodiments, less than or equal to 100%, less than or equal to 90%, less than or equal to 80%, less than or equal to 70%, less than or equal to 60%, less than or equal to 50%, less than or equal to 40%, less than or equal to 30%, or less than or equal to 20% of the plurality of reflective microstructures present within the substrate are arranged in a regular three-dimensional array. Combinations of the above-referenced ranges are also possible (e.g., at least 10% and less than or equal to 100%). Other ranges are also possible.

In some embodiments, the reflective microstructures are produced in a templated process such that the reflective microstructures exhibit a low number of defects. Methods which rely, for example, on assembled microspheres, can be prone to defects. By employing the methods described herein, arrays of reflective microstructures can be fabricated with a defect rate (defined as the percent of reflective microstructures which are malformed and/or misplaced within an array of reflective microstructures) or less than 10% (e.g., less than 5%, less than 1%, or less than 0.5%).

In some embodiments, the plurality of microstructures in the array can have a pitch (measured as the center-to-center distance of adjacent features in the array) of at least 1 micron (e.g., at least 2 microns, at least 3 microns, at least 4 microns, at least 5 microns, at least 6 microns, at least 7 microns, at least 8 microns, at least 9 microns, at least 10 microns, at least 11 microns, at least 12 microns, at least 13 microns, at least 14 microns, at least 15 microns, at least 16 microns, at least 17 microns, at least 18 microns, at least 19 microns, at least 20 microns, at least 25 microns, at least 30 microns, at least 50 microns, or at least 75 microns). In some embodiments, the plurality of microstructures in the array can have a pitch of 100 microns or less (e.g., 75 microns or less, 50 microns or less, 30 microns or less, 25 microns or less, 20 microns or less, 19 microns or less, 18 microns or less, 17 microns or less, 16 microns or less, 15 microns or less, 14 microns or less, 13 microns or less, 12 microns or less, 11 microns or less, 10 microns or less, 9 microns or less, 8 microns or less, 7 microns or less, 6 microns or less, 5 microns or less, 4 microns or less, 3 microns or less, or 2 microns or less).

The plurality of microstructures in the array can have a pitch ranging from any of the minimum values described above to any of the maximum values described above. For example, in some embodiments, the plurality of microstructures in the array can have a pitch of from 1 micron to 100 microns, such as from 1 micron to 30 microns, from 1 micron to 20 microns, from 1 micron to 10 microns, or from 1 micron to 5 microns.

In some embodiments, the first material is transparent (e.g., to a particular wavelength of electromagnetic radiation such as visible light) such that a particular wavelength of electromagnetic radiation (e.g., visible light) may be transmitted through or partially transmitted through the first material and interact with the plurality of microstructure interfaces. While exemplary configurations for substrates having two or more materials, are described above, those skilled in the art would understand based upon the teaching of this specification that additional reconfigurations and rearrangements are also possible (e.g., the third material encapsulating the first and second materials, etc.) (see FIG. 7B). Those skilled in the art would also understand, based upon the teachings of this specification, that substrates comprising four or more, five or more, or six or more materials are also possible and that interfaces between any two of the materials may undergo reflection. Those skilled in the art would also understand, based upon the teachings of this specification, that substrates are comprised of one solid material that has an interface with a gas. In some embodiments, the first material is a reflective material, such as any of those discussed in more detail below.

In some embodiments, the first material can comprise a polymer (e.g., polyethylene, polydimethylsiloxane). In certain embodiments, the polymer is a block copolymer. In certain embodiments, the polymer is a liquid crystal polymer (e.g., a thermotropic liquid crystal polymer, a reflective liquid crystal). In certain embodiments, the polymer is a biopolymer (e.g., gelatin, alginate). Non-limiting examples of suitable polymers include polydimethylsiloxane, polycarbonate, acrylics (e.g., polymethyl methacrylate), polyesters, polyethylene, polyethylene terephthalate, polyethylene glycol, polyolefins, polypropylene, and polystyrene. In certain embodiments, multiple polymers layers are used to create a reflective surface, such as a distributed Bragg reflector. Other polymers are also possible and those of ordinary skill in the art would be capable of selecting such polymers based upon the teachings of this specification.

In some embodiments, the first material can comprise a thermoplastic, such as a polyester, a polyolefin, acrylic, acrylonitrile butadiene styrene (ABS), a polyamide, or any combination thereof. In some embodiments, the first material can comprise a glass. In some embodiments, the first material can comprise a metal. In some embodiments, the first material can comprise a semiconductor.

In some embodiments, the reflective layer can have a thickness of less than 1 micron (e.g., less than 900 nm, less than 800 nm, less than 750 nm, less than 700 nm, less than 600 nm, less than 500 nm, less than 400 nm, less than 300 nm, less than 250 nm, less than 200 nm, less than 100 nm, less than 50 nm, less than 25 nm, or less than 10 nm). In some embodiments, the reflective layer can have a thickness of at least 5 nm (e.g., at least 10 nm, at least 25 nm, at least 50 nm, at least 100 nm, at least 200 nm, at least 250 nm, at least 300 nm, at least 400 nm, at least 500 nm, at least 600 nm, at least 700 nm, at least 750 nm, at least 800 nm, or at least 900 nm).

The reflective layer can have a thickness ranging from any of the minimum values described above to any of the maximum values described above. For example, in some embodiments, the reflective layer can have a thickness of from 5 nm to less than 1 micron, from 5 nm to 250 nm, or from 5 nm to 100 nm.

The reflective layer can be formed from any suitable reflective material or a combination of suitable reflective materials. In some embodiments, the reflective material can comprise an inorganic material. In certain examples, the reflective material does not include a polymer. In certain examples, the reflective material does not include an organic component. In some embodiments, the reflective material can consist of an inorganic material.

In certain embodiments, the reflective material can comprise a metal, such as silver, chromium, gold, platinum, palladium rhodium, iridium, aluminum, titanium, nickel, zinc, copper, iron, vanadium, cobalt, tungsten, zirconium, indium, or combinations thereof. In certain embodiments, the reflective material can comprise an alloy such as stainless steel, nichrome, bronze, rose gold, or white gold. In some embodiments, the reflective layer can comprise a semiconductor (e.g., carbon, silicon, germanium, tin, zinc selenide, or zinc sulfide) or metal oxide (e.g., titanium oxide, magnesium oxide, aluminum oxide, chromium oxide, zinc oxide, or silicon oxide). In some embodiments, the reflective layer can comprise a liquid crystal.

In some embodiments, the reflectivity of the reflective layer (measured at 20° C. at the wavelength of electromagnetic radiation being reflected (i.e., incident to the surface), where reflectivity is defined as the percent of the total electromagnetic radiation incident on 122 that is reflected) can be greater than or equal to 40% (e.g., greater than or equal to 45%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, greater than or equal to 95%, greater than or equal to 98%, or equal to 99%).

Referring again to FIG. 1A, in some embodiments, the substrate can further comprise an inorganic layer (120) disposed on and abutting the reflective layer (108), thereby forming an interface between the reflective surface (122) and the inorganic layer on or within each of the plurality of microstructures.

In some embodiments, the inorganic layer can have a thickness of less than 1 micron (e.g., less than 900 nm, less than 800 nm, less than 750 nm, less than 700 nm, less than 600 nm, less than 500 nm, less than 400 nm, less than 300 nm, less than 250 nm, less than 200 nm, less than 100 nm, less than 50 nm, less than 25 nm, or less than 10 nm). In some embodiments, the inorganic layer can have a thickness of at least 5 nm (e.g., at least 10 nm, at least 25 nm, at least 50 nm, at least 100 nm, at least 200 nm, at least 250 nm, at least 300 nm, at least 400 nm, at least 500 nm, at least 600 nm, at least 700 nm, at least 750 nm, at least 800 nm, or at least 900 nm).

The inorganic layer can have a thickness ranging from any of the minimum values described above to any of the maximum values described above. For example, in some embodiments, the inorganic layer can have a thickness of from 5 nm to less than 1 micron, from 5 nm to 250 nm, or from 5 nm to 100 nm.

In some embodiments, the inorganic layer can comprise a metal oxide, dielectric, semiconductor, or combination thereof. For example, the inorganic layer can comprises aluminum oxide, barium-strontium-titanate (BST), erbium oxide, hafnium oxide, hafnium silicate, lanthanum oxide, niobium oxide, lead-zirconium-titanate (PZT), a bilayer of silicon oxide and silicon nitride, silicon oxy-nitride, strontium titanate (STO), tantalum oxide, titanium oxide, zirconium oxide, silicon, germanium, gallium arsenide, silicon carbide, indium-tin-oxide, gallium nitride, gallium phosphide, cadmium sulfide, lead sulfide, zinc selenide, zinc sulfide, or a combination thereof.

The depositions of materials in the reflective layer and/or the inorganic layer may be selected such that the ordering and thickness of each layer may be controlled in relation to concavity of the composed microstructures. Accordingly, the orientation of the microstructures and ordering of the inorganic film layers may determine the resulting iridescent appearance resulting from the path length differences of impinging light undergoing interference resulting from combination of multiple reflections within micro-scale structures as well as thin film interference generated between the nano-scale oxide or semiconductor and metal film layers.

In some embodiments, the reflective layer (or the inorganic layer when present) can form an interface with air or another gas (e.g., a perfluoropentane gas, oxygen gas, nitrogen gas, helium gas, hydrogen gas, or carbon dioxide gas).

In some embodiments, the reflective layer (or the inorganic layer when present) can form an interface with a liquid (e.g., a hydrocarbon, florocarbon, alcohol, silicone, aqueous solution, water, etc.) Non-limiting examples of suitable hydrocarbons include alkanes (e.g., hexane, heptane, decane, dodecane, hexadecane), alkenes, alkynes, aromatics (e.g., benzene, toluene, xylene, benzyl benzoate, diethyl phalate), oils (e.g., natural oils and oil mixtures including vegetable oil, mineral oil, and olive oil), liquid monomers and/or polymers (e.g., hexanediol diacrylate, butanediol diacrylate, polyethylene glycols, trimethylolpropane ethoxylate triacrylate), alcohols (e.g., butanol, octanol, pentanol, ethanol, isopropanol), ethers (e.g., diethyl ether, diethylene glycol, dimethyl ether), dimethyl formamide, acetonitrile, nitromethane, halogenated liquids (e.g., chloroform, dichlorobenzene, methylene chloride, carbon tetrachloride), brominated liquids, iodinated liquids, lactates (e.g., ethyl lactate), acids (e.g., citric acid, acetic acid), liquid crystals (4-cyano-4′-pentylbiphenyl), trimethylamine, liquid crystal hydrocarbons (e.g., 5-cyanobiphenyl), combinations thereof, and derivatives thereof, optionally substituted. In some embodiments, the hydrocarbon comprises a halogen group, sulfur, nitrogen, phosphorus, oxygen, or the like. Other hydrocarbons are also possible.

Non-limiting examples of suitable fluorocarbons include fluorinated compounds such as perfluoroalkanes (e.g., perfluorohexanes, perfluorooctane, perfluorodecalin, perfluoromethylcyclohexane), perfluoroalkenes (e.g., perfluorobenzene), perfluoroalkynes, and branched fluorocarbons (e.g., perfluorotributylamine). Additional non-limiting examples of suitable fluorocarbons include partially fluorinated compounds such as methoxyperfluorobutane, ethyl nonafluorobutyl ether, 2H,3H-perfluoropentane, trifluorotoluene, perfluoroidodide, fluorinated or partially fluorinated oligomers, 2,2,3,3,4,4,5,5,6,6,7,7,8,8,9,9-hexadecafluorodecane-1,10-diyl bis(2-methylacrylate), perfluoroiodide, and 2-(trifluoromethyl)-3-ethoxydodecafluorohexane, Teflon. Other fluorocarbons are also possible.

In some embodiments, at least one of the two or more materials comprises a silicone such as silicone oil or silicone polymer. Non-limiting examples of suitable silicone oils include polydimethylsiloxane and cyclosiloxane fluids.

In other embodiments, referring again to FIG. 1A, a coating comprising a second material (124) disposed over the reflective layer, so as to form an interface between the second material and the reflective layer and/or inorganic layer.

In some embodiments, the second material comprises a polymer (e.g., polyethylene, polydimethylsiloxane). In certain embodiments, the polymer is a block copolymer. In certain embodiments, the polymer is a liquid crystal polymer (e.g., a thermotropic liquid crystal polymer, a reflective liquid crystal). In certain embodiments, the polymer is a biopolymer (e.g., gelatin, alginate). Non-limiting examples of suitable polymers include polydimethylsiloxane, polycarbonate, acrylics (e.g., polymethyl methacrylate), polyesters, polyethylene, polyethylene terephthalate, polyethylene glycol, polyolefins, polypropylene, and polystyrene. In certain embodiments, multiple polymers layers are used to create a reflective surface, such as a distributed Bragg reflector. Other polymers are also possible and those of ordinary skill in the art would be capable of selecting such polymers based upon the teachings of this specification.

In some embodiments, the second material can comprise a thermoplastic, such as a polyester, a polyolefin, acrylic, acrylonitrile butadiene styrene (ABS), a polyamide, or any combination thereof. In some embodiments, the second material can comprise a glass. In some embodiments, the second material can comprise a metal. In some embodiments, the second material can comprise a semiconductor.

In some embodiments, the first material can comprise a reflective material. In these embodiments, a separate reflective layer need not be present. Referring now to FIG. 1D, also provided herein substrates (200) that comprise a reflective material (202) having a reflective surface (204) and comprising plurality of microstructures (206) disposed on or within the surface (204). The reflective surface (204) is structured such that at least a portion of electromagnetic radiation (216) incident a surface (226) of the substrate (200) at least one illumination angle undergoes multiple reflection events (218) within the microstructure (e.g., resulting in spectral color generation or interference). As with the embodiments described above, each of the microstructures (206) can have a height (212) and a width (214). In some embodiments, each of the microstructures can have a height and a width of at least 1 micron.

Referring again to FIG. 1D, in some embodiments, the substrate can further comprise an inorganic layer (208) disposed on and abutting the reflective material (202), thereby forming an interface between the reflective surface (204) and the inorganic layer on or within each of the plurality of microstructures. In some embodiments, referring again to FIG. 1D, a coating comprising a second material (224) disposed over the reflective material, so as to form an interface between the second material and the reflective material and/or inorganic layer.

In some embodiments, the reflective layer and/or the inorganic layer can comprise multiple layers, such that the microstructure includes a stack comprising a plurality of reflective and/or inorganic layers. For example, in some embodiments, the inorganic layer can comprise a first layer comprising a dielectric and/or a semiconductor (e.g., having a thickness of from 100 microns to 500 microns) and a thin layer comprising a metal (e.g., a layer of metal having a thickness of from 5 microns to 50 microns).

In some embodiments, the first material, the second material, or any combination thereof can further comprise an additive that alters one or more optical properties of the material (e.g., the absorption, transmission, refractive index, or any combination thereof of the material). In this way, the observed optical effects can be modulated. By way of example, in some embodiments, the first material, the second material, or any combination thereof can further comprise a pigment to modulate, for example, structural color exhibited by the substrate.

### Methods of Making Substrates

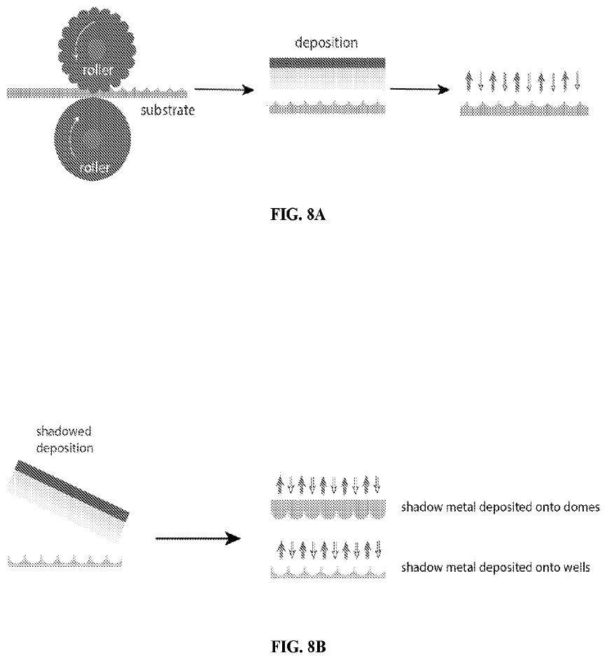

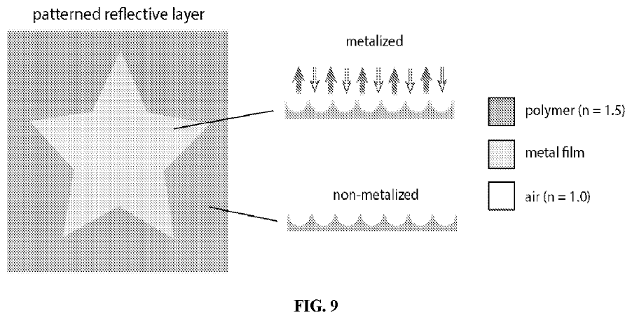

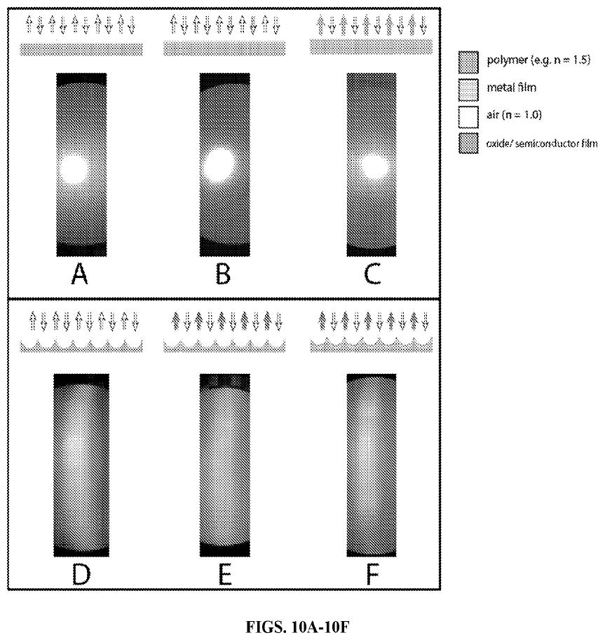

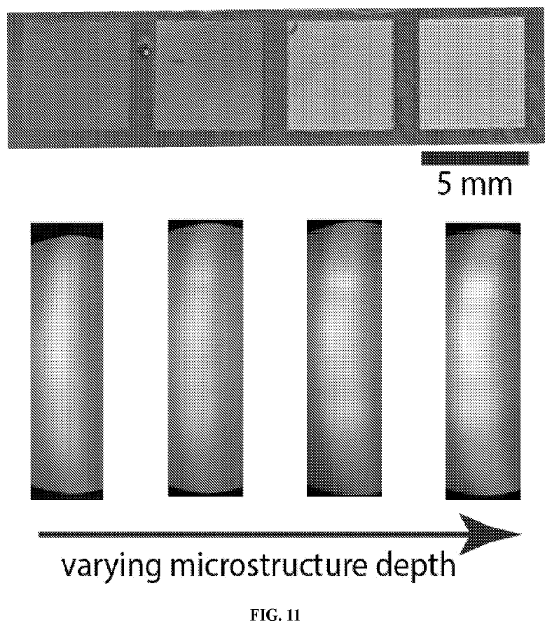

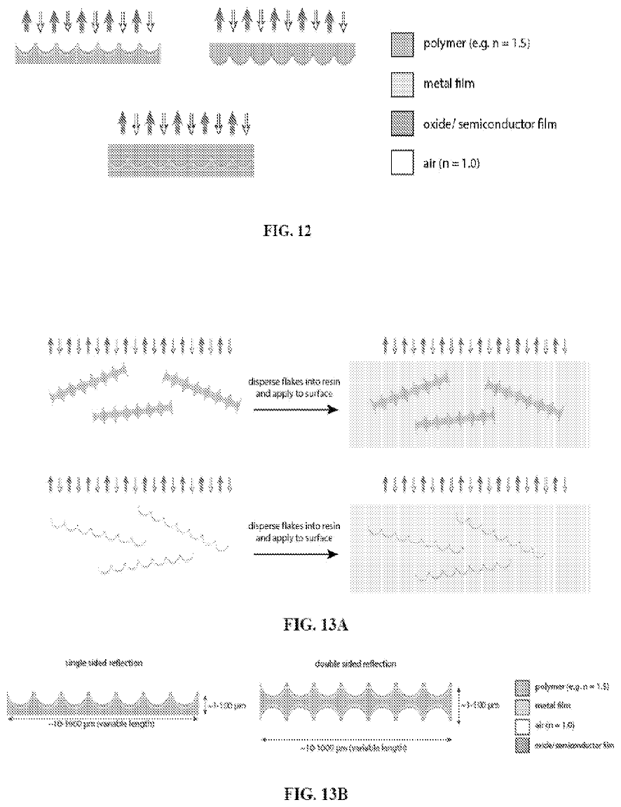

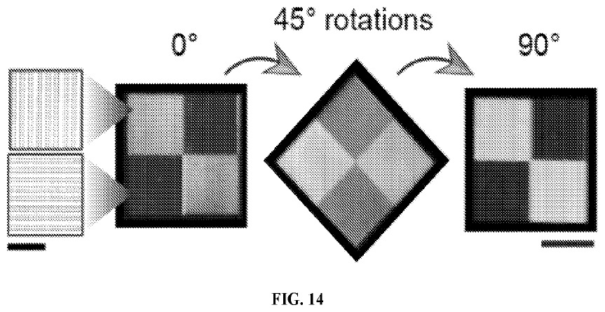

Methods for making microstructured substrates capable of exhibiting an interference pattern upon reflection of incident electromagnetic radiation can employ a variety of microstructure templating, replication and coating processes. Microstructure templating (i.e., mold making) may be used to prepare an interface master comprised of defined patterns of microscale geometries which may be further replicated to produce similar copies used to create reflective substrates. Optionally, providing the interface master can comprise forming the interface master. Microfabrication processes used for structure templating include for example: photolithography, laser ablation, chemical etching, diamond turning or precision machining, particle assembly or by the heat or chemically induced swelling or reflowing of a soft resist material. Once an interface master has been produced, a hard master copy (e.g., a mold fabricated from a metal, ceramic, or high durometer polymer) can be formed to be used to allow for the high-volume replication of the master pattern, provided the surface of the hard master remains intact. For example, conductive metallization and electroforming of the master interface to obtain a mirrored copy from the original. The inverse metal master copy can be further electroformed to obtain a second mirror copy matching the original interface master polarity. Depending on the production requirements and properties of the hard master, various microreplication techniques, such as roll-to-roll (R2R) or plate-to-plate (P2P) may be used to produce patterned substrates with the necessary interface geometries capable of exhibiting interference upon reflection of incident electromagnetic radiation. Substrate replication may be achieved in a variety of materials (e.g., polymers, hydrogels, solgels, carbon, metals, alloys, oxides, ceramics) through processes such as embossing, stamping, forming, or casting techniques known in the art. Depending on the reflective properties of the interface pattern formed during replication, an additional coating process may be used to impart high reflectivity by modifying surface properties through the deposition of additional material layers (e.g., metals, alloys, oxides, fluorides, inorganic films) using processes such as sputtering, chemical vapor deposition, physical vapor deposition, UV casting, solvent casting, printing, spray coating, electrochemical deposition, electroless deposition, chemical plating. An example is illustrated in FIG. 8A, depicting a R2R process (e.g., hot embossing or UV casting) using a hard interface master used to replicate concave microstructure geometries in a polymeric substrate, subsequently followed by the deposition of a reflective metal film on top of the patterned interface. The deposition process for layering a reflective material layer onto a substrate may be conducted in an arrangement that causes asymmetry in the buildup of coating material across different sides of the microstructural features (FIG. 8B). Patterning layers of reflective and non-reflective materials over defined limited areas of substrate may be implemented as a method of patterning the reflective appearance after replication from a hard master to further tune the locations where reflected interference may be visible and personalize the iridescent structure color effect (FIG. 9). Methods for patterning substrates after master replication include masking the deposition or coating of further materials, digital printing or laser marking within limited areas, or etching away or removing the coating from unwanted areas after deposition has taken place. Multiple layers of different materials, or variation in the thickness of materials, can be used to tune the reflection location and amount of reflection across different regions of the substrate.

### Articles and Methods of Use

The substrates described herein provided in a variety of forms, depending on the intended application for the system. In certain embodiments, the substrates can be formed on an article or packaging for the article, for example, by embossing, casting, molding, or stamping an array of reflective microstructures on the article or packaging for the article. In certain embodiments, the substrate can be fabricated, for example, in the form of a film or metallic foil that can be applied to an article or packaging for the article (e.g., using an adhesive). The precise methods whereby the substrates are formed can be selected in view of a number of factors, including the nature of the materials from or within which the substrate is formed, and overall production considerations (e.g., such that the method readily integrates into the manufacture of an article).

The substrates can be employed to provide authentication of articles (e.g., as a security and anti-counterfeiting feature to identify and distinguish authentic products from counterfeit products) and/or to provide visual enhancement of manufactured articles and packaging.

The substrates can be employed in many fields of use and applications. Examples include:
Government and defense applications-whether Federal, State or Foreign (such as Passports, ID Cards, Driver's Licenses, Visas, Birth Certificates, Vital Records, Voter Registration Cards, Voting Ballots, Social Security Cards, Bonds, Food Stamps, Postage Stamps, and Tax Stamps);
currency—whether Federal, State or Foreign (such as security threads in paper currency, features in polymer currency, and features on paper currency);
documents (such as Titles, Deeds, Licenses, Tax Stamps, Diplomas, and Certificates);
financial and negotiable instruments (such as Certified Bank Checks, Corporate Checks, Personal Checks, Bank Vouchers, Stock Certificates, Travelers' Checks, Money Orders, Credit cards, Debit cards, ATM cards, Affinity cards, Prepaid Phone cards, and Gift Cards);
confidential information (such as Movie Scripts, Legal Documents, Intellectual Property, Medical Records/Hospital Records, Prescription Forms/Pads, and “Secret Recipes”);
product and brand protection, including Fabric & Home Care (such as Laundry Detergents, fabric conditioners, dish care, household cleaners, surface coatings, fabric refreshers, bleach, and care for special fabrics);
beauty care (such as Hair care, hair color, skin care & cleansing, cosmetics, fragrances, antiperspirants & deodorants, feminine protection pads, tampons and pantiliners);
baby and family care (such as Baby diapers, baby and toddler wipes, baby bibs, baby change & bed mats, paper towels, toilet tissue, and facial tissue);
health care (such as Oral care, pet health and nutrition, prescription pharmaceuticals, over-the counter pharmaceuticals, drug delivery and personal health care, prescription vitamins and sports and nutritional supplements; prescription and non-prescription eyewear; Medical devices and equipment sold to Hospitals, Medical Professionals, and Wholesale Medical Distributors (e.g., bandages, equipment, implantable devices, surgical supplies);
food and beverage packaging;
dry goods packaging;
electronic equipment, parts & components;
apparel and footwear, including sportswear clothing, footwear, licensed and non-licensed upscale, sports and luxury apparel items, fabric;
biotech pharmaceuticals;
aerospace components and parts;
automotive components and parts;
sporting goods;
tobacco products;
software;
compact disks, DVDs, and Blu-Ray discs;
explosives;
novelty items (such as gift wrap and ribbon)
books and magazines;
school products and office supplies;
business cards;
shipping documentation and packaging;
notebook covers;
book covers;
book marks;
event and transportation tickets;
gambling and gaming applications (such as Lottery tickets, game cards, casino chips and items for use at or with casinos, raffle and sweepstakes);
home furnishing (such as towels, linens, and furniture);
flooring and wallcoverings;
jewelry & watches;
handbags;
art, collectibles and memorabilia;
toys;
food (e.g., on the surface candies including chocolate); displays (such as Point of Purchase and Merchandising displays); and
product marking and labeling (such as labels, hangtags, tags, threads, tear strips, over-wraps, securing a tamperproof image applied to a branded product or document for authentication or enhancement, as camouflage, and as asset tracking).

In certain embodiments, the substrates systems can be employed on a document or packaging for a document. The document can be, for example, a banknote, a check, a money order, a passport, a visa, a vital record (e.g., a birth certificate), an identification card, a credit card, an atm card, a license, a tax stamp, a postage stamp, a lottery ticket, a deed, a title, a certificate, or a legal document. In some embodiments, the substrates can be employed to provide visual enhancement of an article, such as coinage, CDs, DVDs, or Blu-Ray Discs, or packaging, such as aluminum cans, bottles (e.g., glass or plastic bottles), plastic film, or foil wrappers.

In some embodiments, particulates or flakes of the substrate can form a coating composition which can be applied to articles. In some embodiments, the particulates or flakes of the substrate can be dispersed colloidally in a carrier to form an ink or paint. Such compositions can be applied uniformly over a surface, or in a pattern to aesthetically enhance an article and/or to provide for a method of authentication.

What is claimed is:

1. A substrate exhibiting in interference pattern upon illumination by incident electromagnetic radiation, the substrate comprising
a first material having a surface and comprising plurality of microstructures disposed on or within the surface; and
a reflective layer disposed on and abutting the first material, thereby forming a reflective surface on or within each of the plurality of microstructures;
wherein each of the microstructures have a height and a width of at least 1 micron;
wherein the reflective surface is structured such that a portion of electromagnetic radiation incident a surface of the substrate at an illumination angle undergoes two or more reflections within the microstructure, thereby generating an interference pattern upon incident illumination.

2. The substrate of claim 1, wherein at least a portion of the reflective surface is faceted.

3. The substrate of any of claims 1-2, wherein at least a portion of the reflective surface is arcuate.

4. The substrate of any of claims 1-3, wherein at least a portion of the reflective surface is concave relative to the incident electromagnetic radiation.

5. The substrate of any of claims 1-4, wherein the first material is optically transparent within a portion of the electromagnetic spectrum.

6. The substrate of any of claims 1-5, wherein the first material comprises a polymer.

7. The substrate of claim 6, wherein the polymer comprises a thermoplastic, such as a polyester, a polyolefin, acrylic, acrylonitrile butadiene styrene (ABS), a polyamide, or any combination thereof.

8. The substrate of any of claims 1-7, wherein the reflective layer has a thickness of less than 1 micron.

9. The substrate of any of claims 1-8, wherein the reflective layer has a thickness of less than 250 nm, such as a thickness of from 5 nm to 100 nm.

10. The substrate of any of claims 1-9, wherein the reflective layer comprises an inorganic material.

11. The substrate of any of claims 1-10, wherein the reflective layer comprises a metal

12. The substrate of any of claim 11, wherein the metal comprises silver, chromium, gold, platinum, palladium rhodium, iridium, aluminum, titanium, nickel, zinc, copper, iron, vanadium, cobalt, tungsten, zirconium, indium, or combinations thereof.

13. The substrate of any of claims 1-12, wherein the reflective layer comprises an alloy such as stainless steel, nichrome, bronze, rose gold, white gold.

14. The substrate of any of claims 1-10, wherein the reflective layer comprises a semiconductor or metal oxide.

15. The substrate of claim 14, wherein the semiconductor comprises carbon, silicon, germanium, tin, zinc selenide, or zinc sulfide, or wherein the metal oxide can comprise titanium oxide, magnesium oxide, aluminum oxide, chromium oxide, zinc oxide, or silicon oxide.

16. The substrate of any of claims 1-10, wherein the reflective layer comprises a liquid crystal.

17. The substrate of any of claims 1-16, wherein the reflective layer does not comprise a polymer.

18. The substrate of any of claims 1-17, wherein the reflective layer consists of inorganic materials.

19. The substrate of any of claims 1-18, wherein the reflective layer exhibits a reflectivity of at least about 40% upon incident illumination, such as at least 50%, at least 75%, or at least 90%.

20. The substrate of any of claims 1-19, further comprising an inorganic layer disposed on and abutting the reflective layer, thereby forming an interface between the reflective layer and the inorganic layer on or within each of the plurality of microstructures.

21. The substrate of claim 20, wherein the inorganic layer has a thickness of less than 1 micron.

22. The substrate of any of claims 20-21, wherein the inorganic layer has a thickness of less than 250 nm, such as a thickness of from 5 nm to 100 nm.

23. The substrate of any of claims 20-22, wherein the inorganic layer comprises a metal oxide, dielectric, semiconductor, or combination thereof.

24. The substrate of claim 23, wherein the inorganic layer comprises aluminum oxide, barium-strontium-titanate (BST), erbium oxide, hafnium oxide, hafnium silicate, lanthanum oxide, niobium oxide, lead-zirconium-titanate (PZT), a bilayer of silicon oxide and silicon nitride, silicon oxy-nitride, strontium titanate (STO), tantalum oxide, titanium oxide, zirconium oxide, or a combination thereof.

25. The substrate of claim 23, wherein the inorganic layer comprises silicon, germanium, gallium arsenide, silicon carbide, indium-tin-oxide, gallium nitride, gallium phosphide, cadmium sulfide, lead sulfide, zinc selenide, zinc sulfide, or a combination thereof.

26. The substrate of any of claims 1-25, further comprising a coating comprising a second material disposed over the reflective layer.

27. The substrate of claim 26, wherein the second material is optically transparent within a portion of the electromagnetic spectrum.

28. The substrate of any of claims 26-27, wherein the second material comprises a polymer.

29. The substrate of claim 28, wherein the polymer comprises a thermoplastic, such as a polyester, a polyolefin, acrylic, acrylonitrile butadiene styrene (ABS), a polyamide, or any combination thereof.

30. The substrate of any of claims 1-29, wherein each of the plurality of microstructures comprise a hemicylinder.

31. The substrate of any of claims 1-30, wherein each of the plurality of microstructures have a height of from 1 micron to 30 microns, such as from 1 micron to 20 microns, from 1 micron to 10 microns, or from 1 micron to 5 microns.

32. The substrate of any of claims 1-31, wherein each of the plurality of microstructures have a width of from 1 micron to 30 microns, such as from 1 micron to 20 microns, from 1 micron to 10 microns, or from 1 micron to 5 microns.

33. The substrate of any of claims 1-32, wherein each of the plurality of microstructures have an aspect ratio of from 0.1 to 2, such as an aspect ratio of from 0.25 to 2, from 0.5 to 1.5, or from 0.75 to 1.25.

34. The substrate of any of claims 1-33, wherein the plurality of microstructures are disposed in a regular 2-dimensional array.

35. The substrate of any of claims 1-34, wherein the plurality of microstructures are disposed in a regular 3-dimensional array.

36. The substrate of any of claims 34-35, wherein the plurality of microstructures in the array have a pitch of from 1 micron to 100 microns, such as from 2 microns to 30 microns.

37. The substrate of any of claims 34-36, wherein the array comprises a tiling or tessellation covering a portion of the surface of the substrate.

38. The substrate of any of claims 1-37, wherein electromagnetic radiation reflected by the plurality of microstructures exhibits variable intensity based on the illumination angle.

39. The substrate of any of claims 1-38, wherein electromagnetic radiation reflected by the plurality of microstructures exhibits variable intensity based on an angle of observation relative to the surface.

40. The substrate of any of claims 1-39, wherein electromagnetic radiation reflected by the plurality of microstructures exhibits structural color.

41. The substrate of any of claims 1-40, wherein the substrate is micronized to form particulates or flakes that exhibit an interference pattern upon reflection of incident electromagnetic radiation.

42. A substrate exhibiting in interference pattern upon illumination by incident electromagnetic radiation, the substrate comprising
a reflective material having a reflective surface and comprising plurality of microstructures disposed on or within the surface;
wherein each of the microstructures have a height and a width of at least 1 micron;
wherein the reflective surface of each of the plurality of microstructures are structured such that a portion of electromagnetic radiation incident a surface of the substrate at an illumination angle undergoes two or more reflections within the microstructure, thereby generating an interference pattern upon incident illumination.

43. The substrate of claim 42, wherein at least a portion of the reflective surface is faceted.

44. The substrate of any of claims 42-43, wherein at least a portion of the reflective surface is arcuate.

45. The substrate of any of claims 42-44, wherein at least a portion of the reflective surface is concave relative to the incident electromagnetic radiation.

46. The substrate of any of claims 42-45, wherein the reflective material comprises an inorganic material.

47. The substrate of any of claims 42-46, wherein the reflective material comprises a metal

48. The substrate of any of claim 47, wherein the metal comprises silver, chromium, gold, platinum, palladium rhodium, iridium, aluminum, titanium, nickel, zinc, copper, iron, vanadium, cobalt, tungsten, zirconium, indium, or combinations thereof.

49. The substrate of any of claims 42-48, wherein the reflective material comprises an alloy such as stainless steel, nichrome, bronze, rose gold, white gold.

50. The substrate of any of claims 42-49, wherein the reflective material comprises a semiconductor or metal oxide.

51. The substrate of claim 50, wherein the semiconductor comprises carbon, silicon, germanium, tin, zinc selenide, or zinc sulfide, or wherein the metal oxide can comprise titanium oxide, magnesium oxide, aluminum oxide, chromium oxide, zinc oxide, or silicon oxide.

52. The substrate of any of claims 42-51, wherein the reflective layer exhibits a reflectivity of at least about 40% upon incident illumination, such as at least 50%, at least 75%, or at least 90%.

53. The substrate of any of claims 42-52, further comprising an inorganic layer disposed on and abutting the reflective material, thereby forming an interface between the reflective surface and the inorganic layer on or within each of the plurality of microstructures.

54. The substrate of claim 53, wherein the inorganic layer has a thickness of less than 1 micron.

55. The substrate of any of claims 53-54, wherein the inorganic layer has a thickness of less than 250 nm, such as a thickness of from 5 nm to 100 nm.

56. The substrate of any of claims 53-55, wherein the inorganic layer comprises a metal oxide, dielectric, semiconductor, or combination thereof.

57. The substrate of claim 56, wherein the inorganic layer comprises aluminum oxide, barium-strontium-titanate (BST), erbium oxide, hafnium oxide, hafnium silicate, lanthanum oxide, niobium oxide, lead-zirconium-titanate (PZT), a bilayer of silicon oxide and silicon nitride, silicon oxy-nitride, strontium titanate (STO), tantalum oxide, titanium oxide, zirconium oxide, or a combination thereof.

58. The substrate of claim 56, wherein the inorganic layer comprises silicon, germanium, gallium arsenide, silicon carbide, indium-tin-oxide, gallium nitride, gallium phosphide, cadmium sulfide, lead sulfide, zinc selenide, zinc sulfide, or a combination thereof.

59. The substrate of any of claims 42-58, further comprising a coating comprising a second material disposed over the reflective material.

60. The substrate of claim 59, wherein the second material is optically transparent within a portion of the electromagnetic spectrum.

61. The substrate of any of claims 59-60, wherein the second material comprises a polymer.

62. The substrate of claim 61, wherein the polymer comprises a thermoplastic, such as a polyester, a polyolefin, acrylic, acrylonitrile butadiene styrene (ABS), a polyamide, or any combination thereof.

63. The substrate of any of claims 42-62, wherein each of the plurality of microstructures comprise a hemicylinder.

64. The substrate of any of claims 42-63, wherein each of the plurality of microstructures have a height of from 1 micron to 30 microns, such as from 1 micron to 20 microns, from 1 micron to 10 microns, or from 1 micron to 5 microns.

65. The substrate of any of claims 42-64, wherein each of the plurality of microstructures have a width of from 1 micron to 30 microns, such as from 1 micron to 20 microns, from 1 micron to 10 microns, or from 1 micron to 5 microns.

66. The substrate of any of claims 42-65, wherein each of the plurality of microstructures have an aspect ratio of from 0.1 to 2, such as an aspect ratio of from 0.25 to 2, from 0.5 to 1.5, or from 0.75 to 1.25.

67. The substrate of any of claims 42-66, wherein the plurality of microstructures are disposed in a regular 2-dimensional array.

68. The substrate of any of claims 42-66, wherein the plurality of microstructures are disposed in a regular 3-dimensional array.

69. The substrate of any of claims 67-68, wherein the plurality of microstructures in the array have a pitch of from 1 micron to 100 microns, such as from 2 microns to 30 microns.

70. The substrate of any of claims 67-69, wherein the array comprises a tiling or tessellation covering a portion of the surface of the substrate.

71. The substrate of any of claims 42-70, wherein electromagnetic radiation reflected by the plurality of microstructures exhibits variable intensity based on the illumination angle.

72. The substrate of any of claims 42-71, wherein electromagnetic radiation reflected by the plurality of microstructures exhibits variable intensity based on an angle of observation relative to the surface.

73. The substrate of any of claims 42-73, wherein electromagnetic radiation reflected by the plurality of microstructures exhibits structural color.

74. The substrate of any of claims 42-73, wherein the substrate is micronized to form particulates or flakes that exhibit an interference pattern upon reflection of incident electromagnetic radiation.

75. The substrate of any of claims 1-74, wherein the incident electromagnetic radiation comprises visible light, UV light, IR light, or a combination thereof.

76. An article comprising the substrate defined by any of claims 1-75.

77. The article of claim 76, wherein the article comprises a banknote, check, money order, passport, visa, vital record, identification card, credit card, atm card, license, tax stamp, postage stamp, lottery ticket, deed, title, certificate, legal document, packaging component, sticker, or authentication tag.

78. The article of any of claims 76-77, wherein the substrate appears to transform from a first form, shape, size or color to a second form, shape, size or color upon rotation of the article about an axis parallel to the surface.
